(19) United States
(12) Patent Application Publication
(10) Pub. No.: US 2003/0041105 A1
(43) Pub. Date: Feb. 27, 2003

(54) Method and apparatus for queuing clients

(75) Inventor: Kyle N. Patrick, Pitt Meadons (CA)

Correspondence Address: HOFFMAN WARNICK & D'ALESSANDRO, LLC, 3 E-COMM SQUARE, ALBANY, NY, 12207

(73) Assignee: International Business Machines Corporation, Armonk, NY

(21) Appl. No.: 10/215,510

(22) Filed: Aug. 9, 2002

(30) Foreign Application Priority Data
Aug. 10, 2001 (CA) 2,354,990

(51) Int. Cl. G06F 15/16

(52) U.S. Cl. 709/203; 709/219

(57) ABSTRACT

The invention provides an automated system for queuing of clients for limited availability services in a spatially distributed system, such as diners waiting for a waiter in a restaurant. Clients and the service providers, such as waiters, are provided with two-way pagers on a network connected to a queue management server. The client can signal a call for service on its pager and is put into the client queue. When a call for service is made or a service provider becomes available, the server schedules the next available service provider to the first client in the queue and sends a message to each client as to its new position in the queue.

### TECHNICAL FIELD

The invention relates to the field of methods of queuing customers for the distribution of services, and more particularly to a method and an automated system for queuing of clients for limited availability services in a spatially distributed system.

### BACKGROUND ART

In many situations the demand for a particular service by potential users or customers exceeds the supply immediately available from the service provider, and it is therefore necessary to line up or queue the customers in a pre-determined order to provide the service in a way to best achieve the desired result. Generally customers are queued in a first-come, first-served order, such as in a line-up for a movie, or concert tickets, or when consecutively numbered slips are provided to customers to be served at a meat counter, government service desk or the like. Such a system works well because it guarantees that everyone will eventually be served and because it is fair. The person who has waited the longest gets served first. In some situations, however, it is not possible to physically queue the customers or provide a numbered slip since the customers are spatially distributed, such as in a restaurant. In such situations there is uncertainty and anxiety on the part of the customers because they do not know where they stand in the queue. For example, in the area of fine dining, waiters must allocate a limited amount of attention to a number of demanding customers and normally such customers will be uncomfortable if they wait too long without knowing where they stand in line for service. There is therefore a need for a system for the queueing of spatially distributed customers.

### BRIEF SUMMARY OF THE INVENTION

The present invention therefore provides a method of queuing a plurality of clients for services provided by a host, the method comprising the steps of: i) providing a queue managing server adapted to process data, communicate over a data communication network and to store data representing a client queue; ii) providing a client data transmitting, receiving and display device associated with each client, each client transmitting, receiving and display device adapted to display information received from the queue managing server and to send to the queue managing server over a data communication network signals representing a call for service; iii) providing a host data transmitting, receiving and display device associated with the host, the host data transmitting, receiving and display device adapted to display information received from the queue managing server and to send to the queue managing server over a data communication network signals representing a commencement of the host providing service to a client and a completion of the host providing service to a client; iv) one of the clients communicating a call for service to the queue managing server; v) the server, responsive to receiving said client call for service, adding the calling client to the client queue; vi) the server scheduling the host, if available, to the first client in the queue; vii) the server communicating the scheduling of said first client to the host's data transmitting, receiving and display device; viii) removing the first client from the client queue and designating the host as assigned to the first client; and ix) the server communicating to each said client in said queue a message indicative of an updated position of each client in the calling queue.

According to a further aspect the method according to the invention further comprises the steps of: x) the host communicating a start service signal to the server indicating that the host has commenced service of the first client; and xi) the server, responsive to receiving the start service signal, designating said host as busy.

According to a further aspect, the method according to the invention further comprises the steps of: xii) the host communicating a finish service signal to the server indicating that the host has finished service of the first client; xiii) the server, responsive to receiving the finish service signal, scheduling the host to the first client in the client queue; and xiv) the server communicating a message to all clients indicative of an updated position of the clients in the client queue.

According to yet a further aspect, the method according to the invention further comprises the steps of: xv) one of the clients in the client queue communicating a cancel service signal to the queue managing server; and xvi) the server, responsive to receiving the cancel service signal, removing the cancelling client from the client queue and communicating a message to each client indicative of an updated position of the clients in the client queue.

The present invention further provides a method of queuing clients distributed in a plurality of zones for services provided by a plurality of hosts, the method comprising the steps of: i) providing a queue managing server adapted to process data, communicate over a data communication network and to store data representing a client queue corresponding to each zone and a host queue corresponding to each zone; ii) providing a client data transmitting, receiving and display device associated with each client, each client transmitting, receiving and display device adapted to display information received from the queue managing server and to send to the queue managing server over a data communication network signals representing a call for service; iii) providing a host data transmitting, receiving and display device associated with each host, each host data transmitting, receiving and display device adapted to display information received from the queue managing server and to send to the queue managing server over a data communication network signals representing a commencement of the host providing service to a client and a completion of the host providing service to a client; iv) one of the clients communicating a call for service to the queue managing server; v) the server, responsive to receiving the client call for service, adding the calling client to the client queue in the calling client's zone; vi) the server scheduling an available host in the calling client's zone to the first client in the queue for the calling client's zone; vii) the server communicating said scheduling to the available host's data transmitting, receiving and display device; and viii) removing the first client from the calling client's queue and removing the available host from the host queue; and ix) the server communicating to each client in the calling client's zone queue a message indicative of an updated position of the clients in the calling client's queue.

According to a further aspect of the invention, the invention further comprises a data processing system for queuing clients distributed in a plurality of zones for services provided by a plurality of hosts, the data processing system comprising: i) a queue managing server adapted to process data, communicate over a data communication network and to store data representing a client queue corresponding to each zone and a host queue corresponding to each zone; ii) a client data transmitting, receiving and display device associated with each client, each client transmitting, receiving and display device adapted to display information received from the queue managing server and to send to the queue managing server over a data communication network signals representing a call for service; iii) a host data transmitting, receiving and display device associated with each host, each host data transmitting, receiving and display device adapted to display information received from the queue managing server and to send to the queue managing server over a data communication network signals representing a commencement of the host providing service to a client and a completion of said host providing service to a client; iv) means for one of the clients to communicate a call for service to the queue managing server; v) means for the server, responsive to receiving the client call for service, to add the calling client to the client queue in the calling client's zone; vi) means for the server to schedule an available host in the calling client's zone to the first client in the queue for the calling client's zone; vii) means for the server to communicate said scheduling to the available host's data transmitting, receiving and display device; viii) means for removing the first client from the calling client's queue and removing the available host from the host queue; ix) means for the server to communicate a message to all clients in the calling client's zone indicative of an updated position of the clients in the calling client's queue.

According to yet a further aspect of the invention there is provided a computer program product for queuing a plurality of clients for services provided by a host using a queue managing server adapted to process data, communicate over a data communication network and to store data representing a client queue; a client data transmitting, receiving and display device associated with each client, each client transmitting, receiving and display device adapted to display information received from the queue managing server and to send to the queue managing server over the data communication network signals representing a call for service; and a host data transmitting, receiving and display device associated with each host, each host data transmitting, receiving and display device adapted to display information received from the queue managing server and to send to the queue managing server over the data communication network signals representing a commencement of the host providing service, the computer program product comprising: a computer usable medium having computer readable program code means embodied in the medium for: receiving one of the clients communication of a call for service to the queue managing server and for the server, responsive to receiving the client call for service, to add the calling client to the client queue; scheduling the host to the first client in the queue; communicating the scheduling to said host's data transmitting, receiving and display device; removing the first client from the client's queue; and communicating to each client in the client's queue a message indicative of an updated position of the client in the queue.

According to yet a further aspect of the invention there is provided a computer program product for queuing clients distributed in a plurality of zones for services provided by a plurality of hosts using a queue managing server adapted to process data, communicate over a data communication network and to store data representing a client queue corresponding to each zone and a host queue corresponding to each zone; a client data transmitting, receiving and display device associated with each client, each client transmitting, receiving and display device adapted to display information received from the queue managing server and to send to the queue managing server over a data communication network signals representing a call for service; and a host data transmitting, receiving and display device associated with each host, each host data transmitting, receiving and display device adapted to display information received from the queue managing server and to send to the queue managing server over a data communication network signals representing a commencement of the host providing service, said computer program product comprising: a computer usable medium having computer readable program code means embodied in the medium: for receiving one of the clients communication of a call for service to said queue managing server and for the server, responsive to receiving the client call for service, to add the calling client to the client queue in the calling client's zone; for the server to schedule an available host in the calling client's zone to the first client in the queue for the calling client's zone; for the server to communicate said scheduling to said available host's data transmitting, receiving and display device; for removing the first client from the calling client's queue and removing the available host from the host queue; and for the server to communicate to each client in the calling client's zone's queue a message indicative of an updated position of the clients in the calling client's queue.

### BRIEF DESCRIPTION OF THE DRAWINGS

In the drawings, which disclose one preferred embodiment of the invention:

FIG. 1 is a block diagram illustrating a system for implementing the invention;

FIG. 2 is a schematic illustration of a Client pager according to the present invention;

FIG. 3 is a schematic illustration of a Host pager according to the present invention;

FIG. 4 is a state transition diagram illustrating a system for implementing the invention;

FIG. 5 is a table illustrating messages displayed on a Host pager according to the present invention; and

FIG. 6 is a table illustrating messages displayed on a Client pager according to the present invention.

### DETAILED DESCRIPTION OF THE INVENTION

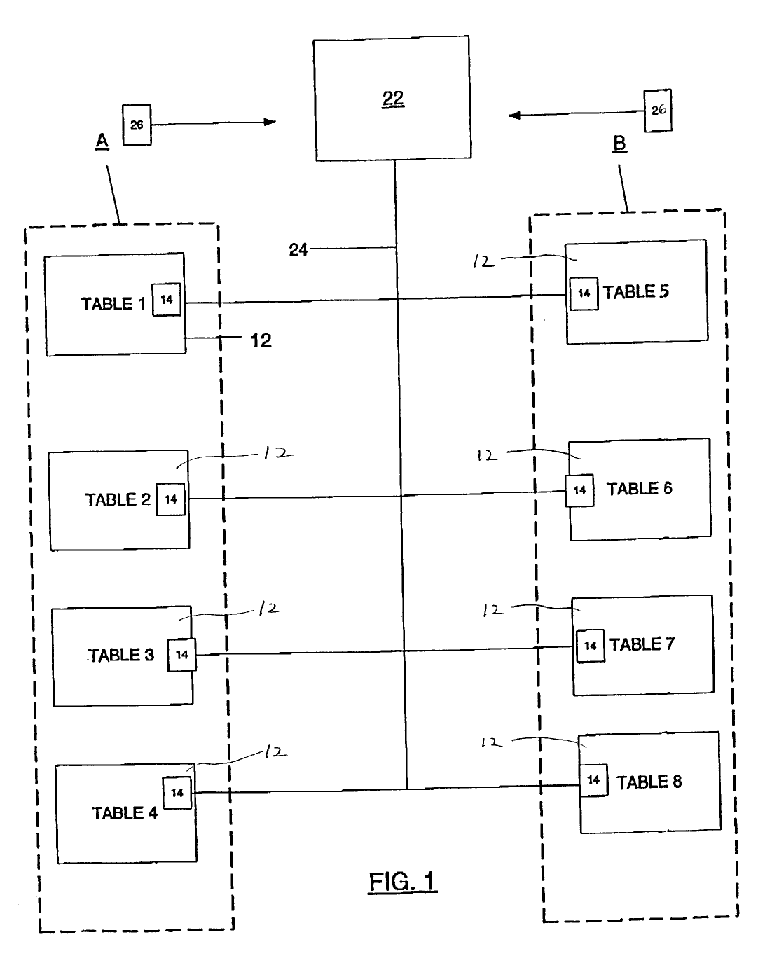

With reference to FIG. 1, a restaurant includes a number of tables 12 numbered 1 through 8 for the seating of diners (referred to herein as “clients”). The tables are divided into two zones or sections A and B, the tables in each section being the responsibility of a different waiter (referred to herein as the “Host”). For example, Host A has responsibility for tables 1 through 4 and Host B has responsibility for tables 5 through 8. While described in an application where there are multiple Hosts and multiple zones, the invention is also useful in an application where there is only one Host and more than one client in a single zone.

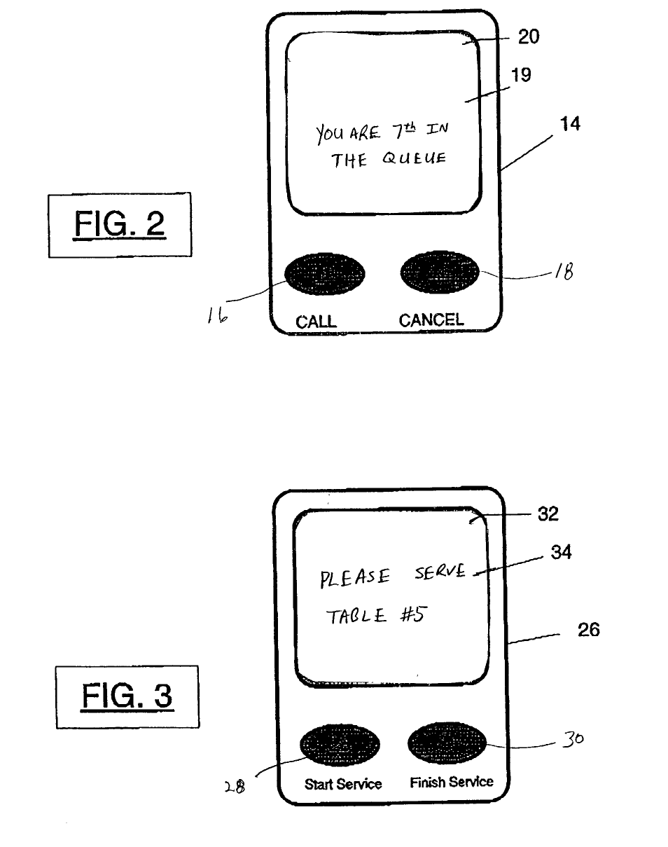

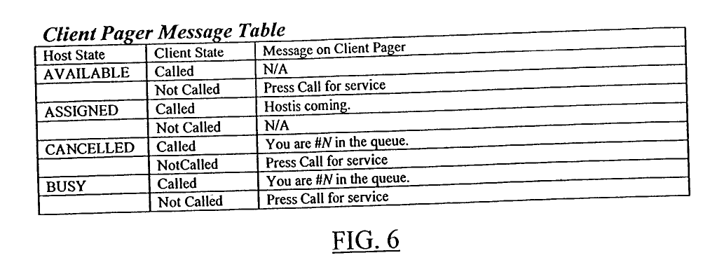

Each table 12 is provided with a networked data transmitting, receiving and display device 14 (FIG. 2), referred to herein as a “client pager 14” which has a “call” button 16, “cancel” button 18 and a screen display 20 for displaying one of a number of messages as shown in FIG. 6. Client pagers 14 are networked to the queue manager network server 22 by network lines 24, or alternatively by wireless connection. Client pagers 14 each have a unique client identification no. (“client ID”) to identify the table to the server 22.

Each Host also carries, or otherwise has access to a networked data transmitting, receiving and display device 26 (FIG. 3), referred to herein as a “Host pager 26”, which has a “Start Service” button 28 , “Finish Service” button 30 and a screen display 32 for displaying one of a number of messages as shown in FIG. 5. Host pagers 26 are similarly networked to the queue manager network server 22 by wireless connection, or alternatively by network lines 24. Host pagers 26 each have a unique host identification no. (“hostID”) to identify the Host to the server 22.

The queue manager network server 22 maintains a client queue for each zone comprising the tables needing attention, and a queue for available Hosts. Server 22 carries out all calculations so that the pagers need only transmit signals and display messages sent by the queue manager.

In operation, a client at a given table 12 desiring service, for example when ready to order or when desiring to change an order, presses the “call” button 16 and a CALL signal carrying the client ID and zone number is sent to the server 22. The server 22 looks up the client by client ID to determine if that client ID is already in the queue for that zone. If the client is already in the queue, the server does nothing. If the client is not in that zone's queue, then the client is added to the end of the queue belonging to the zone in which the client is in. The server 22 then schedules a Host to the first client in the queue for that zone, as described below. The server checks the Host queue to determine if a Host in that zone is available. If a Host is available, then the Host is assigned to the table of the first client in the queue and that client and Host are removed from their respective queues. The server 22 then sends update messages, as further described below, to all client and Host pagers, which provides a message 19 to each client pager 14 telling the clients their position in the queue. Thus, periodically new messages are sent to the client pager as the client's position in the queue changes. The server 22 also sends a message to the selected Host informing him or her that he/she has been assigned to a particular table.

If a client at a given table 12 wishes to cancel a request for service, the client presses the “cancel” button 18 and a signal carrying the client ID is sent to the server 22. The server 22 looks up the client by client ID to determine if that client ID is already in the queue for that zone. If that client is not in the queue for that zone, then the server does nothing. If the client is in the queue for that zone, then the client is removed from the queue belonging to the zone in which the client is in. If the client was assigned to a Host then the client is unassigned to the Host, the Host is sent to the CANCELLED state and clients and Hosts are updated as described below. A message is sent to the client pager so that “Press Call for Service” is displayed, and an update message is sent to client and Host pagers.

Host pagers 26 receive messages 34 that inform them when, and which table has been assigned to the Host. When a Host receives an assignment, the client message for that table reads “Host is coming” and the Host will go to the designated table. When the Host activates the Start Service button 28 on the Host pager 26, which sends a SERVICE_STARTED message to the queue manager server 22, the queue manager then sends a message to the client pager 14 for the client being serviced so that the message “Press Call for service” is again displayed to permit the client to make a further service call. The queue manager will also send a message to the Host pager 26 so that a “busy” message is displayed on display 32. The Host will perform the service requested by the client and then activate the Finish Service button 30 that will send a SERVICE_FINISHED message to the queue manager server 22 that the Host is available for a new service request. The queue manager will then change the Hosts's state to “AVAILABLE” and send back a message so that an “Available” message is displayed on the Host pager display 32. The Host is then added to the Host queue for that zone and the queue manager server 22 schedules the next Host in the queue to the next client in the queue.

A scheduling event occurs at queue manager server 22 for a particular zone whenever a CALL or SERVICE_FINISHED message is received from a client pager or Host pager in that zone. Each time a scheduling event occurs in a zone, the server updates clients and Hosts by running a scheduling routine for that zone. To assign Hosts to the next client in the client queue, the server selects the zone and loops through the Hosts to locate the first available Host in the Host queue for that zone. If there is no available Host in that zone, or no clients in the client queue for that zone, then it exits the sub-routine. If there is an available Host and at least one client in the client queue, the server then selects the first client from the queue for that zone, removes the client from the queue and assigns the selected Host to that client. The Host's state is set to “ASSIGNED”, and the server updates clients and Hosts as follows. To update Hosts, the server loops through the collection of Hosts for that zone and sends a network message as set out in FIG. 5 to each recipient host ID according to that Host's state. The server then loops through the collection of clients for that zone and sends a network message to each recipient client ID as set out in FIG. 6, according to that Host's state and that client's state.

According to one variant, the client pagers could have an indicator light turned on when queued (“Called”), while the one waiting the longest (at the head of the queue) could have a flashing light.

Thus according to the invention, the server 22 assigns one of two states to each client ID, either CALLED or NOT CALLED. The server assigns one of four states to each host ID: AVAILABLE, ASSIGNED, CANCELLED or BUSY. Each client pager can send one of two signals to the server 22, “CALL” or “CANCEL”. Each Host pager can send one of two signals to the server 22, “START SERVICE” or “FINISH SERVICE”.

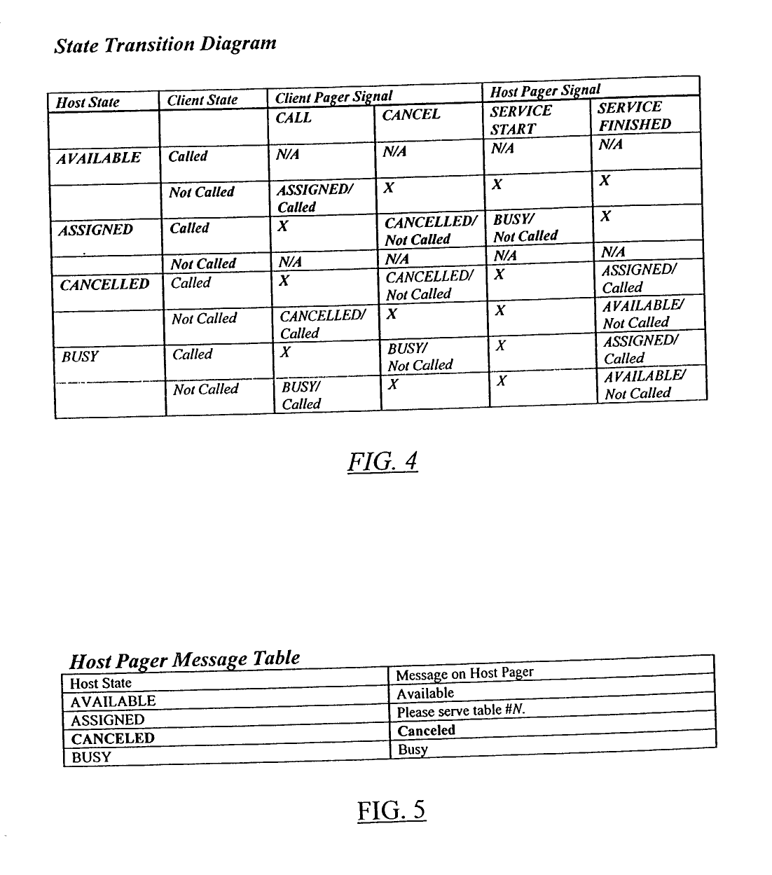

FIG. 4 illustrates the changes in state which are made by server 22 upon receipt of a signal from a Host or client. An “X” in FIG. 4 means there is no change in state. “N/A” in FIG. 4 means that the combination of states should not occur. When the Host's state is “AVAILABLE” and the client is “Not Called”, a “CALL” signal from the client pager will change the Host state to “ASSIGNED” and the client state to “Called”. When the Host's state is “ASSIGNED” and the client is “Called”, a “CANCEL” signal from the client pager will change the Host state to “CANCELLED” and the client state to “Not Called”. When the Host's state is “ASSIGNED” and the client is “Called”, a “START SERVICE” signal from the Host pager will change the Host state to “BUSY” and the client state to “Not Called”. When the Host's state is “CANCELLED” and the client is “Called” a “CANCEL” signal from the client pager will change the client state to “Not Called”. When the Host's state is “CANCELLED” and the client is “Called” a “FINISH SERVICE” signal from the Host pager will change the Host state to “ASSIGNED”. When the Host's state is “CANCELLED” and the client is “Not Called”, a “CALL” signal from the client pager will change the client state to “Called”. When the Host's state is “CANCELLED” and the client is “Not Called”, a “FINISH SERVICE” signal from the Host pager will change the Host state to “AVAILABLE”. When the Host's state is “BUSY” and the client is “Called”, a “CANCEL” signal from the client pager will change the client state to “Not Called”. When the Host's state is “BUSY” and the client is “Called”, a “FINISH SERVICE” signal from the Host pager will change the Host state to “ASSIGNED” and will change the client state to “Called”. When the Host's state is “BUSY” and the client is “Not Called”, a “CALL” signal from the client pager will change the client state to “Called”. When the Host's state is “BUSY” and the client is “Not Called”, a “FINISH SERVICE” signal from the Host pager will change the Host state to “AVAILABLE.

FIG. 5 illustrates the messages which are displayed on the Host pager display 32 for a given Host state as communicated to Host pager 32 in an update message. When the Host's state is “AVAILABLE” the message displayed is “Available”. When the Host's state is “ASSIGNED” the message displayed is “Please serve table #N”, where N is the actual number of table 12 which is associated with a clientID as shown in FIG. 1. When the Host's state is “CANCELLED” the message displayed is “Cancelled”. When the Host's state is “BUSY” the message displayed is “Busy”.

FIG. 6 illustrates the messages which are displayed on the client pager display 20 for a given Host state and client state, as communicated to client pager 14 in an update message. “N/A” in FIG. 6 means that the combination of states should not occur. When the Host's state is “AVAILABLE” and the client is “Not Called”, the message displayed is “Press Call for service”. When the Host's state is “ASSIGNED” and the client is “Called”, the message displayed is “Host is coming”. When the Host's state is “CANCELLED” and the client is “Called”, the message displayed is “You are #N in the queue”, where N is the position of the client in the client queue for the client's zone. When the Host's state is “CANCELLED” and the client is “Not Called”, the message displayed is “Press Call for service”. When the Host's state is “BUSY” and the client is “Called”, the message displayed is “You are #N in the queue”. When the Host's state is “BUSY” and the client is “Not Called”, the message displayed is “Press Call for service”.

The following pseudo code illustrates how the system may be programmed.

Data Structures on Queue Manager
Table type containing:

isCalled: boolean
assignedHost: Host
zone: Zone (set at initialization time)
id: Integer (set at initialization time)

Host type containing

state: AVAILABLE, ASSIGNED, BUSY or CANCELLED
assignedTable: Table
zone: Zone (set at initialization time)
id (set at initialization time)

TableQueue type holding:

ordered collection of tables

HostQueue type holding:

ordered collection of hosts

Zone type containing

collection of hosts
collection of tables
TableQueue
HostQueue

zones collection

collection of zone

Events on Queue Manager
Queue Manager is responsive to four events:

| | |
|---|---|
| OnTableCall | (from table pager) |
| OnTableCancel | (from table pager) |
| OnServiceStarted | (from host pager) |
| OnServiceFinished | (from host pager) |

Messages Generated by Queue Manager
Queue Manager generates two messages

Message update to client pager
Message update to host pager

Data Structures on Client Pager
zone (set at initialization time)
id (set at initialization time)
Events on Client Pager
Client pager is responsive to four events:

Call widget activated
Cancel widget activated
Message update received from Queue Manager

Messages Generated by Client Pager

| | |
|---|---|
| CALL | (to Queue Manager) |
| CANCEL | (to Queue Manager) |

Data Structures on Host Pager
zone (set at initialization time)
id (set at initialization time)
Events on Host Pager
Host pager is responsive to five events:

Service Started widget activated
Service Finished widget activated
Message update received from Queue Manager

Messages Generated by Host Pager

| | |
|---|---|
| SERVICE_STARTED | (to Queue Manager) |
| SERVICE_FINISHED | (to Queue Manager) |

Pseudo Code for Queue Manager
All methods on Queue Manager are synchronized to avoid threading problems.
OnReceiveMessage(id, zoneId, message) {//low level dispatch mechanism

zone = zones.getZone(zoneId); // get zone from zones collection
if (message == CALL) {

table = zone.getTable(id); // get table based on table id
OnTableCall(table, zone); // call event handler

} else if (message == CANCEL) {

table = zone.getTable(id);
OnTableCancel(table, zone);

} else if (message == SERVICE_STARTED) {

host = zone.getHost(id); // get host based on host id
OnServiceStarted(host, zone);

} else if (message == SERVICE_FINISHED) {

host = zone.getHost(id);
OnServiceFinished(host, zone);

}

}
OnTableCall(table, zone) {

if ( not table.isCalled) {//has not already called

table.isCalled = true;
zone.getTableQueue().append(table); // add to queue
schedule(zone); // try to get host to serve request
broadcastUpdates(zone); // tell pagers

}

}
OnTableCancel(table, zone) {

if (table.isCalled) {

table.isCalled = false; // no longer calling

// remove from queue if in it

zone.getTableQueue().remove(table);
// inform host not required
cancelHost(table, zone);
broadcastUpdates(zone);

}

}
OnServiceStarted(host, zone) {

If (host.state == ASSIGNED) {// is host assigned to table

host.assignedTable.isCalled = false;
host.assignedTable.assignedHost = null;
host.state = BUSY;
broadcastUpdates(zone);

}

}
OnServiceFinished(host, zone) {
// if host is performing order or canceled

If (host.state == BUSY OR host.state == CANCELLED) {

host.state == AVAILABLE; // host is available
host.assignedTable = null;
zone.getHostQueue().append(host); // add to host queue
schedule(zone); // see if there is table needing service
broadcastUpdates(zone);

}

}
schedule(zone) {// associate first table and host

if (zone.getTableQueue(zone).isNotEmpty() AND
zone.getHostQueue(zone).isNotEmpty()) {

table = zone.getTableQueue(zone).getAndRemoveFirst();
host = zone.getHostQueue(zone).getAndRemoveFirst();
table.assignedHost = host;
host.assignedTable = table;
host.state = ASSIGNED;

}

}
cancelHost(table, zone) {

if (not table.assignedHost=null) {

table.assignedHost.assignedTable == null;
table.assignedHost.state = CANCELLED;

}

}
broadcastUpdates(zone) {// broadcast of all host/table state

index = 1
for all table in zone.getTableQueue() {

sendMessageToTable(table.id,
“You are #” + index + “in the queue.”);
index = index + 1;

}
for all table in zone.getTables() {

if (zone.getTableQueue().notIn(table)) {

if (table.isCalled) {
// not in queue and called so

// must be assigned to host.

sendMessageToTable(table.id,

“Host is coming.”);

} else {

sendMessageToTable(table.id,

NOT_CALLED, “Press Call for service.”);

}

}

}
for all host in zone.getHostQueue().getAll() {

sendMessageToHost(host.id, “Available”);

}
for all host in zone.getHosts() {

if (zone.getHostQueue.notIn(host)) {

if (host.state == BUSY) {

sendMessageToHost(host.id, “Busy”);

} else if (host.state == CANCELED) {

sendMessageToHost(host.id, “Cancelled”);

} else {

sendMessageToHost(host.id,
“Please serve table #”+host.table.id “+.”);

}

}
}

}
Pseudo Code for Client Device
// send call message to queue manager when call widget activated
OnCallWidgetActivated() {

sendMessageToQueueManager(id, zone, CALL);

}
// send cancel message to queue manager when cancel widget activated
OnCancelWidgetActivated() {

sendMessageToQueueManager( id, zone, CANCEL);

}
// display message on thin client
OnReceiveMessage(action, message) {

updateDisplayWithMessage(message);

}
Pseudo Code for Host Device
// send message on widget activation
OnServiceStartedWidgetActivated() {

sendMessageToQueueManager( id, zone, SERVICE_STARTED);

}
// send message on widget activation
OnServiceFinishedWidgetActivated() {

sendMessageToQueueManager( id, zone, SERVICE_FINISHED);

}
OnReceiveMessage(action, message) {// display message

updateDisplayWithMessage(message);

}

The present invention is described above as a computer-implemented method and data processing system. It may also be embodied as a computer hardware apparatus, computer software code or a combination of same. The invention may also be embodied as a computer-readable storage medium embodying code for implementing the invention. Such storage medium may be magnetic or optical, hard or floppy disk, CD-ROM, firmware or other storage media.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A method of queuing a plurality of clients for services provided by a host, the method comprising the steps of:
i) providing a queue managing server adapted to process data, communicate over a data communication network and to store data representing a queue of clients awaiting service, said queue comprising an ordered representation of a first client calling for service and of clients subsequently calling for such service, ordered sequentially in temporal order of said clients' call for service;
ii) providing a client data transmitting, receiving and display device associated with each client, each said client transmitting, receiving and display device adapted to display information received from said queue managing server and to send to said queue managing server over a data communication network signals representing a call for service;
iii) providing a host data transmitting, receiving and display device associated with said host, said host data transmitting, receiving and display device adapted to display information received from said queue managing server and to send to said queue managing server over a data communication network signals representing a commencement of said host providing service to a client and a completion of said host providing service to a client;
iv) one of said clients communicating a call for service to said queue managing server;
v) said server, responsive to receiving said client call for service, adding said calling client to said queue;
vi) said server scheduling said host, if available, to the first client in said queue;
vii) said server communicating said scheduling to said host's data transmitting, receiving and display device;
viii) removing said first client from said queue and designating said host as assigned to said first client; and
ix) said server communicating to each said client in said queue indicative of a message an updated position of each said client in said queue.

2. A method according to claim 1, further comprising the steps of:
x) said host communicating a start service signal to said server indicating that said host has commenced service of said first client; and
xi) said server, responsive to receiving said start service signal, designating said host as busy.

3. The method according to claim 2, further comprising the steps of:
xii) said host communicating a finish service signal to said server indicating that said host has finished service of said first client;
xiii) said server, responsive to receiving said finish service signal, scheduling said host to the first client in said queue; and
xiv) said server communicating a message to each client indicative of an updated position of said clients in said queue.

4. The method according to claim 3, said method comprising the further steps of:
xv) one of said clients in said queue communicating a cancel service signal to said queue managing server; and
xvi) said server, responsive to receiving said cancel service signal, removing said cancelling client from said queue.

5. A method of queuing a plurality of clients distributed in a plurality of zones for services provided by a plurality of hosts, the method comprising the steps of:
i) providing a queue managing server adapted to process data, communicate over a data communication network and to store data representing a client queue corresponding to each zone and a host queue corresponding to each zone;
ii) providing a client data transmitting, receiving and display device associated with each client, each said client transmitting, receiving and display device adapted to display information received from said queue managing server and to send to said queue managing server over a data communication network signals representing a call for service;
iii) providing a host data transmitting, receiving and display device associated with each host, each host data transmitting, receiving and display device adapted to display information received from said queue managing server and to send to said queue managing server over a data communication network signals representing a commencement of said host providing service to a client and a completion of said host providing service to a client;
iv) one of said clients communicating a call for service to said queue managing server;
v) said server, responsive to receiving said client call for service, adding said calling client to said client queue in said calling client's zone;
vi) said server scheduling an available host in said calling client's zone to the first client in said queue for said calling client's zone;
vii) said server communicating said scheduling to said available host's data transmitting, receiving and display device;
viii) removing said first client from said calling client's queue and removing said available host from said host queue; and
ix) said server communicating a message to each said client in said calling client's zone indicative of an updated position of said clients in said calling client's queue.

6. A method according to claim 5, further comprising the steps of:
x) said host communicating a start service signal to said server indicating that said host has commenced service of said first client; and
xi) said server, responsive to receiving said start service signal, designating said host as busy.

7. The method according to claim 6, further comprising the steps of:
xii) said host communicating a finish service signal to said server indicating that said host has finished service of said first client;
xiii) said server, responsive to receiving said finish service signal, designating said host as available, adding said host to the bottom of said host queue and scheduling an available host in said host's zone to the first client in said queue for said host's zone; and
xiv) said server communicating a message to each client in said host's zone indicative of an updated position of said clients in said host's zone's client queue.

8. The method according to claim 7, said method comprising the further steps of:
xv) one of said clients communicating a cancel service signal to said queue managing server; and
xvi) said server, responsive to receiving said cancel service signal, removing said cancelling client from said client queue in said cancelling client's zone and communicating a message to all clients in said client's zone indicative of an updated position of said clients in said client's zone's client queue.

9. A data processing system for queuing a plurality of clients for services provided by a host, said data processing system comprising:
i) a queue managing server adapted to process data, communicate over a data communication network and to store data representing a queue of clients awaiting service, said queue comprising an ordered representation of a first client calling for service and of clients subsequently calling for such service, ordered sequentially in temporal order of said clients' call for service;
ii) a client data transmitting, receiving and display device associated with each client, each said client transmitting, receiving and display device adapted to display information received from said queue managing server and to send to said queue managing server over said data communication network signals representing a call for service;
iii) a host data transmitting, receiving and display device associated with each host, each host data transmitting, receiving and display device adapted to display information received from said queue managing server and to send to said queue managing server over a data communication network signals representing a commencement of said host providing service to a client and a completion of said host providing service to a client;
iv) means for said server, responsive to receiving said client call for service, to add said calling client to said queue;
v) means for said server to schedule an available host to the first client in said queue;
vi) means for said server to communicate said scheduling to said available host's data transmitting, receiving and display device;
vii) means for removing said first client from said queue; and
viii) means for said server to communicate to each client in said queue a message indicative of an updated position of said clients in said queue.

10. A data processing system according to claim 9, further comprising:
ix) means for said host to communicate a start service signal to said server indicating that said host has commenced service of said first client; and
x) means for said server, responsive to receiving said start service signal, to designate said host as busy.

11. A data processing system according to claim 10, further comprising:
xi) means for said host to communicate a finish service signal to said server indicating that said host has finished service of said first client;
xii) means for said server, responsive to receiving said finish service signal, to designate said host as available, and to schedule said host to the first client in said queue; and
xiii) means for said server to communicate to each client in said queue a message indicative of an updated position of each said client in said queue.

12. The data processing system according to claim 11 further comprising:
xiv) means for one of said clients to communicate a cancel service signal to said queue managing server;
xv) means for said server, responsive to receiving said cancel service signal, to remove said cancelling client from said queue; and
xvi) means for communicating a message to each client in said client's zone indicative of an updated position of said clients in said client's zone's client queue.

13. A data processing system for queuing clients distributed in a plurality of zones for services provided by a plurality of hosts, said data processing system comprising:
i) a queue managing server adapted to process data, communicate over a data communication network and to store data representing a client queue corresponding to each zone and a host queue corresponding to each zone;
ii) a client data transmitting, receiving and display device associated with each client, each said client transmitting, receiving and display device adapted to display information received from said queue managing server and to send to said queue managing server over a data communication network signals representing a call for service;
iii) a host data transmitting, receiving and display device associated with each host, each host data transmitting, receiving and display device adapted to display information received from said queue managing server and to send to said queue managing server over a data communication network signals representing a commencement of said host providing service to a client and a completion of said host providing service to a client;
iv) means for one of said clients to communicate a call for service to said queue managing server;
v) means for said server, responsive to receiving said client call for service, to add said calling client to said client queue in said calling client's zone;
vi) means for said server to schedule an available host in said calling client's zone to the first client in said queue for said calling client's zone;
vii) means for said server to communicate said scheduling to said available host's data transmitting, receiving and display device;
viii) means for removing said first client from said calling client's queue and removing said available host from said host queue; and
ix) means for said server to communicate a message to each client in said calling client's zone's queue indicative of an updated position of each said clients in said calling client's queue.

14. A data processing system according to claim 13, further comprising:
x) means for said host communicating a start service signal to said server indicating that said host has commenced service of said first client; and
xi) means for said server, responsive to receiving said start service signal designating said host as busy.

15. A data processing system according to claim 14, further comprising:
xii) means for said host communicating a finish service signal to said server indicating that said host has finished service of said first client;
xiii) means for said server, responsive to receiving said finish service signal designating said host as available, adding said host to the bottom of said host queue and scheduling an available host in said host's zone to the first client in said queue for said host's zone; and
xiv) means for said server communicating a message to each client in said host's zone's client queue indicative of an updated position of said clients in said host's zone's client queue.

16. The data processing system according to claim 15 further comprising:
xv) means for one of said clients communicating a cancel service signal to said queue managing server; and
xvi) means for said server responsive to receiving said cancel service signal, removing said cancelling client from said client queue in said cancelling client's zone.

17. A computer program product for queuing a plurality of clients for services provided by a host using a queue managing server adapted to process data, communicate over a data communication network and to store data representing a client queue; a client data transmitting, receiving and display device associated with each client, each said client transmitting, receiving and display device adapted to display information received from said queue managing server and to send to said queue managing server over said data communication network signals representing a call for service; and a host data transmitting, receiving and display device associated with each host, each host data transmitting, receiving and display device adapted to display information received from said queue managing server and to send to said queue managing server over said data communication network signals representing a commencement of said host providing service, said computer program product comprising:
a computer usable medium having computer readable program code means embodied in said medium for: receiving one of said clients communication of a call for service to said queue managing server and for said server, responsive to receiving said client call for service, to add said calling client to said client queue; scheduling said host to the first client in said queue; communicating said scheduling to said host's data transmitting, receiving and display device; removing said first client from said client's queue; and communicating to each client in said client's queue a message indicative of an updated position of said clients in said queue.

18. A computer program product according to claim 17 wherein said computer usable medium further comprises computer readable program code means embodied in said medium for communicating a start service signal from said host to said server indicating that said host has commenced service of said first client; and designating said host as busy at said server, responsive to receiving said start service signal.

19. A computer program product according to claim 17 wherein said computer usable medium further comprises computer readable program code means embodied in said medium for: said host to communicate a finish service signal to said server indicating that said host has finished service of said first client; said server, responsive to receiving said finish service signal, to schedule said host to the first client in said queue; and said server to communicate a message to each client indicative of an updated position of said clients in said queue.

20. A computer program product according to claim 17 wherein said computer usable medium further comprises computer readable program code means embodied in said medium for one of said clients in said queue to communicate a cancel service signal to said queue managing server; and for said server, responsive to receiving said cancel service signal, to remove said cancelling client from said queue.

21. A computer program product for queuing clients distributed in a plurality of zones for services provided by a plurality of hosts using a queue managing server adapted to process data, communicate over a data communication network and to store data representing a client queue corresponding to each zone and a host queue corresponding to each zone; a client data transmitting, receiving and display device associated with each client, each said client transmitting, receiving and display device adapted to display information received from said queue managing server and to send to said queue managing server over a data communication network signals representing a call for service; and a host data transmitting, receiving and display device associated with each host, each host data transmitting, receiving and display device adapted to display information received from said queue managing server and to send to said queue managing server over a data communication network signals representing a commencement of said host providing service, said computer program product comprising:
a computer usable medium having computer readable program code means embodied in said medium: for receiving one of said clients communication of a call for service to said queue managing server and for said server, responsive to receiving said client call for service, to add said calling client to said client queue in said calling client's zone; for said server to schedule an available host in said calling client's zone to the first client in said queue for said calling client's zone; for said server to communicate said scheduling to said available host's data transmitting, receiving and display device ; for removing said first client from said calling client's queue and removing said available host from said host queue; and for said server to communicate to each client in said calling client's zone's queue a message indicative of an updated position of said clients in said calling client's queue.

22. A computer program product according to claim 21 wherein said computer usable medium further comprises computer readable program code means embodied in said medium for said host to communicate a start service signal to said server indicating that said host has commenced service of said first client; and for said server, responsive to receiving said start service signal, to designate said host as busy.

23. A computer program product according to claim 21 wherein said computer usable medium further comprises computer readable program code means embodied in said medium for: said host to communicate a finish service signal to said server indicating that said host has finished service of said first client; and for said server, responsive to receiving said finish service signal, to designate said host as available, add said host to the bottom of said host queue and schedule an available host in said host's zone to the first client in said queue for said host's zone; and for said server to communicate a message to each client in said host's zone indicative of an updated position of said clients in said host's zone's client queue.

24. A computer program product according to claim 21 wherein said computer usable medium further comprises computer readable program code means embodied in said medium for one of said clients to communicate a cancel service signal to said queue managing server; and for said server, responsive to receiving said cancel service signal, to remove said cancelling client from said client queue in said cancelling client's zone and communicate a message to each client in said client's zone indicative of an updated position of said clients in said client's zone's client queue.
